(19) United States
(12) Patent Application Publication
(10) Pub. No.: US 2018/0144420 A1
(43) Pub. Date: May 24, 2018

(54) PROVIDING A VIRTUAL QUEUE FOR A RESTAURANT OR BAR

(71) Applicant: MATHEW LEE, COAL CITY, IL (US)

(72) Inventor: MATHEW LEE, COAL CITY, IL (US)

(21) Appl. No.: 15/357,271

(22) Filed: Nov. 21, 2016

(51) Int. Cl. G06Q 50/12; G06Q 10/02

(52) U.S. Cl. CPC G06Q 50/12; H04W 88/02; G06Q 10/02

(57) ABSTRACT

An system and method for making or taking a reservation for a table in a restaurant or bar enables customers using an App on their mobile devices to determine how long the line is for tables and drinks, as well as the ability to actually enter into a virtual queue. Restaurant owners can now broadcast their wait times, as well as enable customers to make reservations and drink orders using their mobile devices, while informing the customers of what position they are in the virtual queue.

### TECHNICAL FIELD

The present invention relates to a method and system for making reservations, and in particular to a method and system for placing prospective clients in a queue for a table or drink order at a restaurant or bar.

### BACKGROUND

Customers get angry when they have to wait in line, and even more frustrated when they perceive that someone has been given preferential treatment with service ahead of them and out of turn.

The following patents are related to the general art of reservations, which are herein incorporated by reference for their supportive teachings, and are as follows: U.S. Pat. No. 8,622,292, by Katz, teaches a reservation based preauthorization payment system; U.S. Pat. No. 5,724,520, by Goheen, teaches an electronic ticketing and reservation system and method; U.S. Pat. No. 8,160,906, by Smith et al., teaches of a system and method for improved rental vehicle reservation management; and U.S. Pat. No. 6,694,234, by Lockwood et al., teaches of a customer service automation system and method.

An object of the present invention is to overcome the shortcomings of the prior art by providing a method and system for automatically putting customers in a virtual queue for a table or drink order so that they can see on their mobile device exactly how many people are in front of them in line.

### SUMMARY OF THE INVENTION

In view of the foregoing disadvantages inherent in the known types of apparatus like in the prior art, the present invention provides an improved apparatus. As such, the general purpose of the present invention, which will be described subsequently in greater detail, is to provide a new and improved apparatus with all the advantages of the prior art and none of the disadvantages.

Accordingly, the present invention relates to a method of taking a reservation comprising:

a) receiving a table availability request about a selected restaurant via a communication network from a user using a mobile device application;

b) sending current table availability from the selected restaurant via the communication network to the mobile device application, or, if no tables are available, a current queue number of how many pending requests for tables are currently being processed;

c) receiving a reservation for an available table or, if no tables are available, a request for a confirmed queue number for a future available table; and

d) sending confirmation of the available table or the confirmed queue number.

Another aspect of the present invention relates to a method of making a reservation comprising:

providing an application for a mobile device capable of communicating via a mobile communication network and capable of:

a) requesting a table availability request about a selected restaurant via a communication network from a user using a mobile device application;

b) receiving current table availability from the selected restaurant via the communication network to the mobile device application, or, if no tables are available, a current queue number of how many pending requests for tables are currently being processed;

c) requesting a reservation for an available table or, if no tables are available, a request for a confirmed queue number for a future available table; and

d) receiving a confirmation of the available table or the confirmed queue number.

Another feature of the present invention provides a method of making a food or drink order comprising:

providing an application for a mobile device capable of communicating via a mobile network, and capable of:

requesting a menu from a selected restaurant via a communication network on a mobile device application;

receiving the current menu from the selected restaurant via the communication network on the mobile device application, as well as a current queue number of how many pending requests are currently being processed;

requesting an item from the menu; and

receiving confirmation of the request and an confirmed queue number representing how many pending requests from other patrons are currently being processed.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 is a schematic diagram of the reservation system in accordance with the present invention;

FIG. 2 is a sign-in screen for a mobile application interface in accordance with the present invention;

FIG. 3 is an initial selection screen for the mobile application interface of FIG. 2;

FIG. 4 a restaurant type selection screen for the mobile application interface of FIG. 2

FIG. 5 is specific restaurant selection screen for the mobile application interface of FIG. 2

FIG. 6 an restaurant features selection screen for the mobile application interface of FIG. 2

FIG. 7 is an restaurant table selection screen for the mobile application interface of FIG. 2; and

FIG. 8 is a settings screen for the mobile application interface of FIG. 2

### DETAILED DESCRIPTION

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

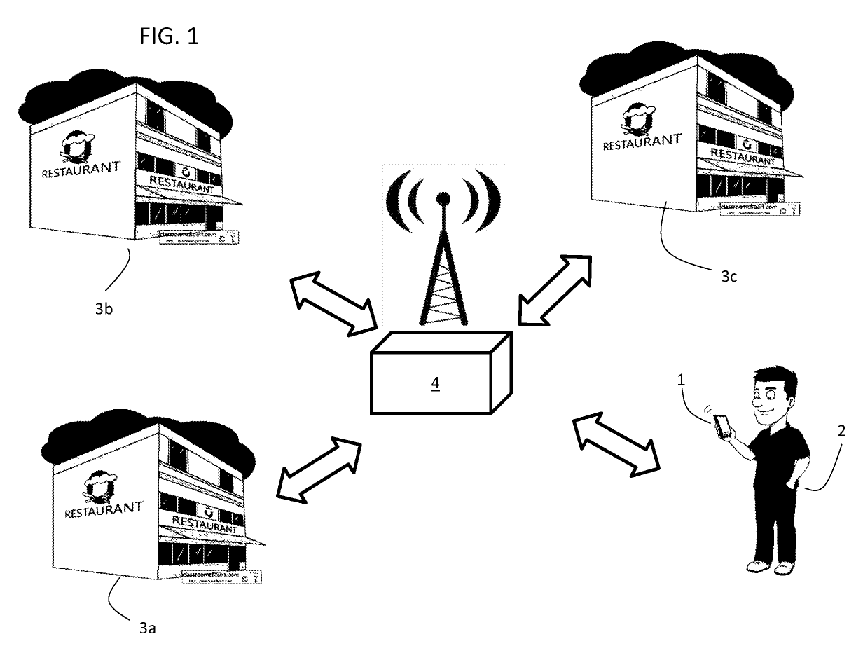

Determining which bar to go to can often be a difficult processes. Location and wait times are important factors that must be considered before an ultimate decision can be made. With reference to FIG. 1, the present invention provides a mobile application for a smart phone or other mobile device 1 of a user 2 that makes selection of which bar, e.g. bars 3a, 3b or 3c, to go to much easier. With the help of the App, the user 1 contacts a central processor 4, which includes a database of all available restaurants and bars categorized according to various criteria, e.g. favorites, location, food type, etc. over an available communication network, e.g. cellphone, internet etc. The central processor 4 may be in an individual restaurant or bar or in a central location in communication with the various restaurants and bars over the same or alternate communication network to provide availability information, as hereinafter discussed.

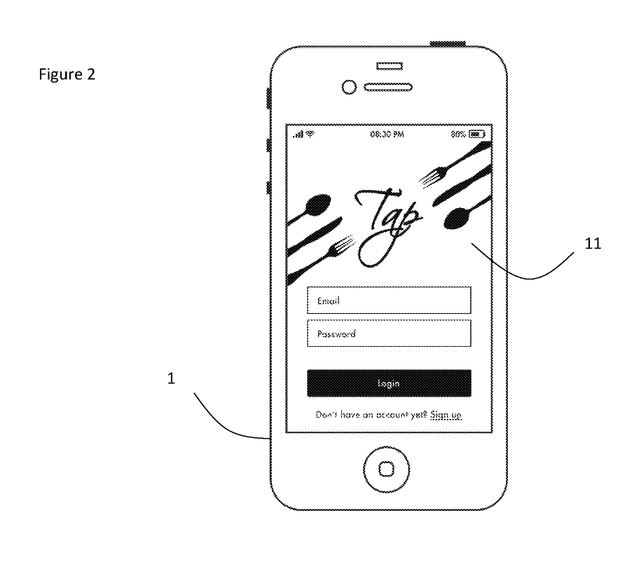

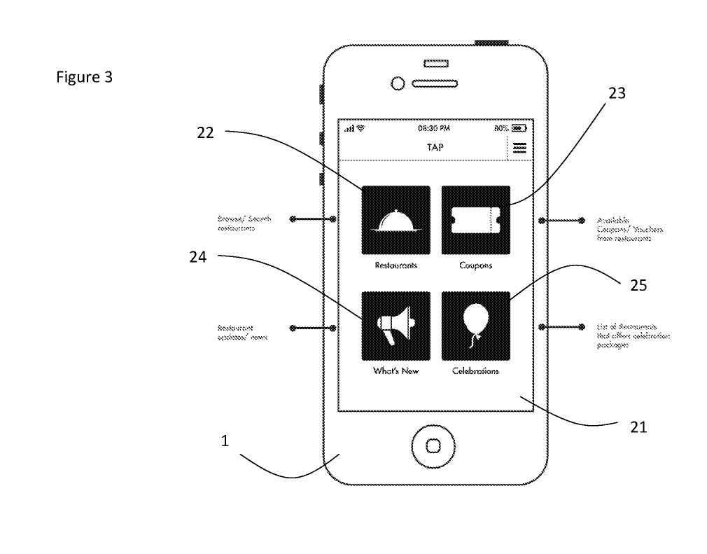

With reference to FIG. 2, after downloading the App into non-transitory memory in the smart phone or other mobile device 1 and setting up a username and password on a user interface screen 11, as is well known in this day and age, the user 2 logs into the system in communication with the central processor 4 and proceeds to the initial selection screen 21, illustrated in FIG. 3. A processor in the mobile device 1 is thereby capable of executing the App, which is capable of performing many of the following functions, including displaying various screens, accepting inputs, and the receipt and transmission of various signals. The central processor 4 may also be capable of executing software stored in associated non-transitory memory to perform many of the functions hereinafter described. The initial selection screen 21, may include a general selection tab 22 for restaurants or bars, as well as other information tabs for such things as current deals, e.g. Coupons tab 23; news or new locations, e.g. “What's New” tab 24; and group packages or parties, e.g. Celebrations tab 25.

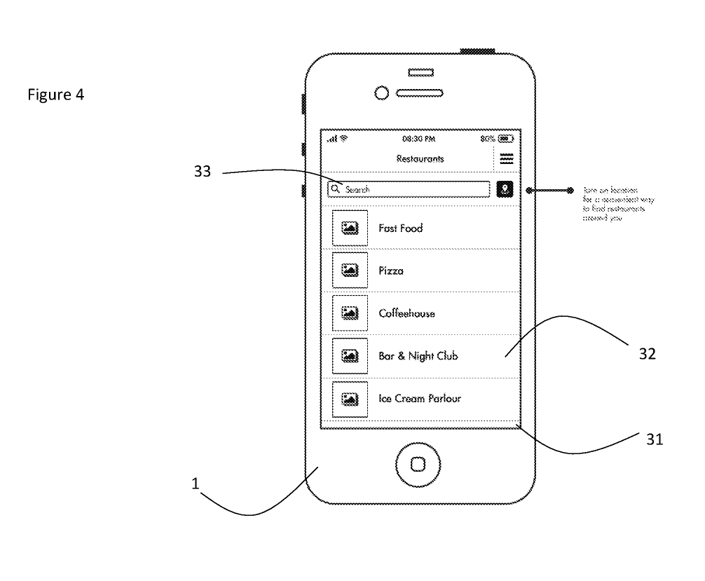

When the Restaurant tab 22 is selected, a restaurant type selection screen 31, FIG. 4, will appear with a list 32 of a variety of choices for the particular type of food or drink, e.g. fast food; pizza; coffeehouse; bar & night club; and ice cream. The selection screen 31 also provides a search option 33, if the type of restaurant is not available.

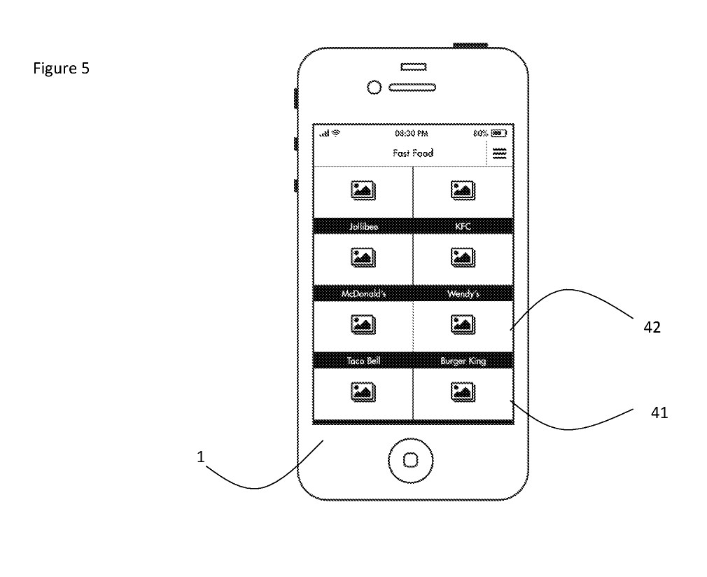

With reference to FIG. 5, if, for example, the fast food tab was selected, a specific restaurant selection screen 41, will appear with a list 42 of specific fast food restaurants, e.g. McDonalds, Burger King etc. or a list of local bars and nightclubs selected from a database stored in the user's mobile device 1 or the central processor 4.

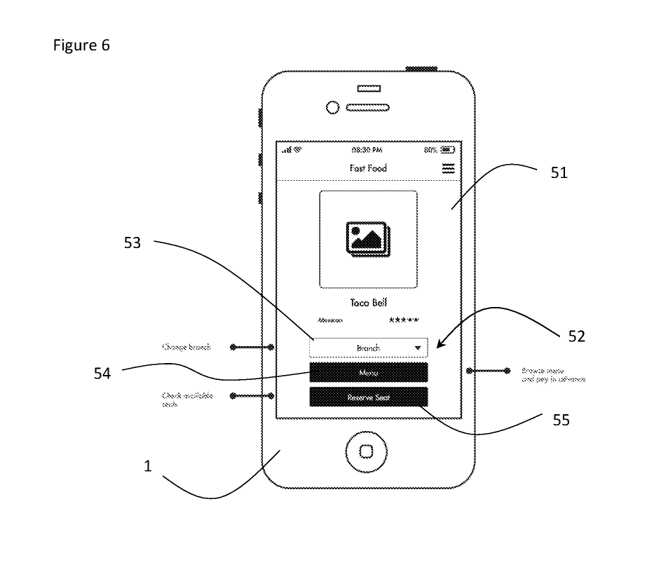

Referring to FIG. 6, when a specific restaurant or bar is selected a restaurant features screen 51 is displayed including a list 52 of features for that specific restaurant, such as branch 53, menu 54 and reserve seat 55. Once the specific branch 53 is selected and the menu 54 is checked, if necessary, then the reserve seat tab 55 is selected to determine whether there are any available tables for seating at a desired time for a selected number of people. Menu and/or seating requests are sent to the specific restaurant directly or via the central processor 4, and availability information is then sent by the specific restaurant and received by the mobile device 1.

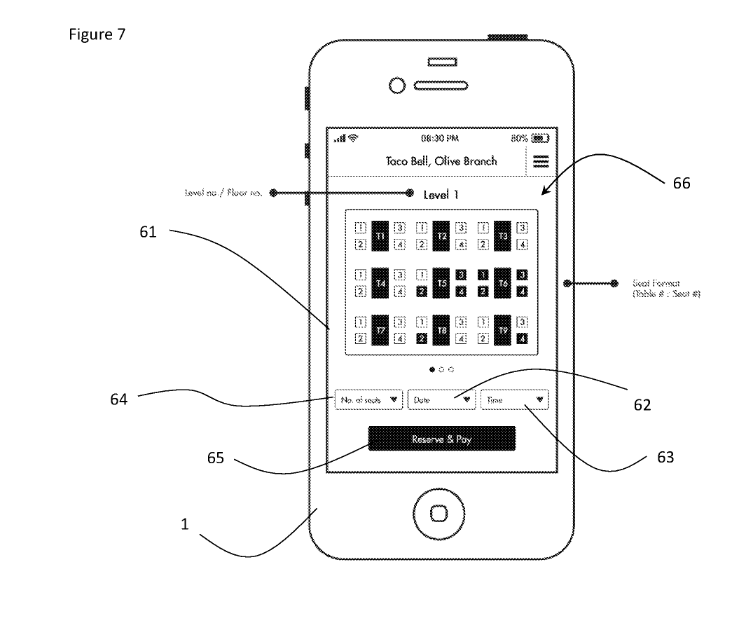

A reservation screen 61 is then displayed by the App, as in FIG. 7, with options for such things as date 62, time 63 and seats required 64. If there is a table available, a reservation message is sent back from the restaurant, via the communication network directly or from the central processor 4 confirming the reservation. If a table is unavailable at the selected time, a queue number is sent to the user 2 via the reservation screen 61 providing the current number of other pending reservations that are in the queue ahead of the user 2. If the user 2 wishes to enter the queue, a reserve tab 65 is selected sending the request back to the restaurant, and a confirmation signal with a confirmed queue number is sent back to the user 2 from the restaurant.

Alternatively, a plurality of restaurants may be selected at the previous stage, and after the date 62, time 63 and seats required 64 information is entered by the user, each of the plurality of restaurants, e.g. 3a, 3b and 3b, will provide their availability to the user 2 at the same time, including seats available or a current queue number.

Ideally, with reference to FIG. 7, a plan of the restaurant 66 may be provided with the reservation screen 61 to provide additional options, such as size and location of table, for the user 2 to choose by selecting the desired table on the plan 66.

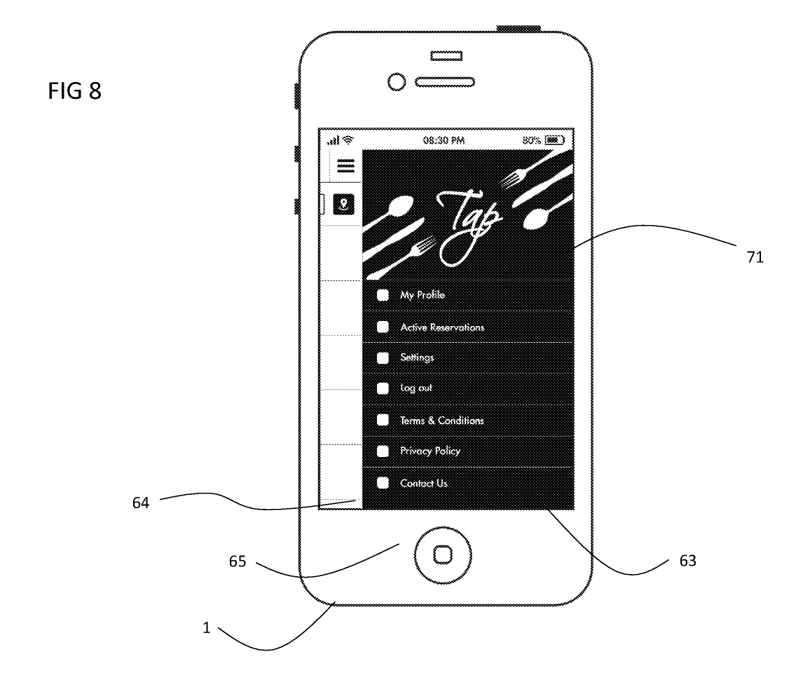

FIG. 8 illustrates setting screen 71 providing access to typical App information, such as My Profile, Settings, Log Out, Terms and Conditions, Privacy Policy and Contact Us, along with App specific information, such as Active Reservations etc.

Once your queue number is called or counts down to 1, the user 2 presents their mobile device 1 to the hostess at the selected restaurant or bar, and proceeds to their selected table.

Now that the user 2 is seated, they can now use the App to order drinks or food. In response to a user request, a menu of possible items is displayed on their screen, such as hereinbefore described, or a menu item box is displayed for entry of words describing the item. A current queue number may also be sent to provide the user with an indication of how long the current line is. The user 2 may then provide their order via the App, and in response, the original controller 4 or a different restaurant-specific controller sends the user 2 a confirmation with the confirmation queue number for the bar or kitchen. Another benefit of the present system is the knowledge of how long the line is for food or drinks, so that the user 2 may adjust their order accordingly. For example, if their queue number happens to be 12 then they may order 2 drinks, so they won't have to wait as long next time. Alternatively, if the user 2 is half way done with their drink, they order when there is 10 customers ahead of them, so that by the time the drink arrives, they are ready for a new one. Accordingly, the system alleviates all customer service issues, race, religion, sex, etc. and makes the customer responsible for keeping themselves in the front of the line. Therefore, there will be less reasons for bad tips or free meals, drinks etc. Moreover, the system of the present invention keeps a bartender from favoring their friends or the opposite sex.

Ideally, the menu screen will also be able to take payment, e.g. from credit or debit cards, and scan IDs, so that when the user 2 gets to the desired location, the entry process becomes quick and easy. Accordingly, the present invention prepares the user's mind for what kind of wait they have in store, and ensures great customer services, while keeping favoritism out of the picture for a bartender and complaints to a minimum.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptions or variations of the present invention.

We/I claim as follows:

1. A method of taking a reservation comprising:
a) receiving a table availability request about a selected restaurant via a communication network from a user using a mobile device application;
b) sending current table availability from the selected restaurant via the communication network to the mobile device application, or, if no tables are available, a current queue number of how many pending requests for tables are currently being processed;
c) receiving a reservation for an available table or, if no tables are available, a request for a confirmed queue number for a future available table; and
d) sending confirmation of the available table or the confirmed queue number.

2. The method according to claim 1, wherein step b) includes sending a map of the selected restaurant, and wherein step c) includes receiving a reservation for a specific table from the map.

3. The method according to claim 1, wherein step a) includes receiving a list of restaurants based on a selected criteria; and wherein step b) includes sending current queue numbers for each of the list of restaurants.

4. The method according to claim 3, wherein the selected criteria is based on location, and wherein the list of restaurants is selected from a database of restaurants based on GPS locations of restaurants in the database relative to the user.

5. The method according to claim 3, wherein the selected criteria is based on current queue number.

6. The method according to claim 1, further comprising:
receiving a request for a menu from the selected restaurant via a communication network on the mobile device application;
sending the current menu from the selected restaurant via the communication network on the mobile device application, as well as a current queue number of how many pending requests are currently being processed;
receiving a request for an item from the menu; and
sending confirmation of the request and a confirmed queue number representing how many pending requests from other patrons are currently being processed.

7. A method of making a reservation comprising:
providing an application for a mobile device capable of communicating via a mobile communication network and capable of:
a) requesting a table availability request about a selected restaurant via a communication network from a user using a mobile device application;
b) receiving current table availability from the selected restaurant via the communication network to the mobile device application, or, if no tables are available, a current queue number of how many pending requests for tables are currently being processed;
c) requesting a reservation for an available table or, if no tables are available, a request for a confirmed queue number for a future available table; and
d) receiving a confirmation of the available table or the confirmed queue number.

8. The method according to claim 7, wherein step b) includes receiving a map of the selected restaurant, and wherein step c) includes requesting a reservation for a specific table from the map.

9. The method according to claim 7, wherein step a) includes requesting a list of restaurants based on a selected criteria; and wherein step b) includes receiving current queue numbers for each of the list of restaurants.

10. The method according to claim 9, wherein the selected criteria is based on location, and wherein the list of restaurants is selected from a database of restaurants based on GPS locations of restaurants in the database relative to the user.

11. The method according to claim 9, wherein the selected criteria is based on current queue number.

12. The method according to claim 7, wherein the application is further capable of:
requesting a menu from the selected restaurant via a communication network;
receiving the current menu from the selected restaurant via the communication network, as well as a current queue number of how many pending requests are currently being processed;
requesting an item from the menu;
receiving confirmation of the request and an confirmed queue number representing how many pending requests from other patrons are currently being processed.

13. A method of making a food or drink order comprising:
providing an application for a mobile device capable of communicating via a mobile network, and capable of:
requesting a menu from a selected restaurant via a communication network on a mobile device application;
receiving the current menu from the selected restaurant via the communication network on the mobile device application, as well as a current queue number of how many pending requests are currently being processed;
requesting an item from the menu; and
receiving confirmation of the request and an confirmed queue number representing how many pending requests from other patrons are currently being processed.

14. The method according to claim 13, wherein the application is further capable of sending payment details for paying for the food or drink order.
